(19) United States
(12) Patent Application Publication
(10) Pub. No.: US 2025/0072402 A1
(43) Pub. Date: Mar. 6, 2025

(54) BIRD SEED FEEDER

(71) Applicant: James Walker Gick, Fallbrook, CA (US)

(72) Inventor: James Walker Gick, Fallbrook, CA (US)

(21) Appl. No.: 18/241,921

(22) Filed: Sep. 4, 2023

(51) Int. Cl. A01K 39/01

(52) U.S. Cl. CPC A01K 39/0113

(57) ABSTRACT

The present invention relates to a bird seed feeder designed to address common challenges associated with traditional bird feeding. The bird seed feeder comprises two main components: an upper bowl and a lower bowl, both constructed from transparent material to maximize visibility. The upper bowl features a large entry hole and a circular perch, providing birds with easy access to seeds while maintaining a natural appearance. Hooks protruding from the lower bowl facilitate hanging the feeder from branches or other supports, enhancing pest deterrence and placement versatility. A stepped, overlapping joint mechanism near the bottom of the assembly deters larger birds, squirrels, and pests from disturbing the feeding environment. The feeder's innovative design significantly reduces mess by containing spilled seeds and waste, preventing weed growth, and promoting a cleaner and more controlled feeding area. Additionally, the transparent construction enhances bird-watching experiences, while user-friendly features, such as a seed filling entry hole and easy maintenance, contribute to its overall functionality. This bird seed feeder represents a notable advancement in the field of bird feeding, offering improved aesthetics, efficiency, and an enhanced connection with nature for bird enthusiasts.

### FIELD OF THE INVENTION

The present invention relates to bird feeders and, more particularly, to a bird seed feeder that significantly reduces mess and waste caused by birds while feeding, thus enhancing the overall bird feeding experience for wild bird enthusiasts.

### BACKGROUND OF THE INVENTION

Bird feeding, also known as avian feeding, is the practice of providing food to wild birds, typically in outdoor settings such as gardens, yards, or parks. People engage in bird feeding for various reasons, including fostering a connection with nature, observing and enjoying the beauty of birds, and contributing to bird conservation efforts. People often use bird feeders for several reasons each driven by their unique interests and motivations. One of the primary reasons people use bird feeders is to observe and enjoy the beauty of wild birds. Bird feeding provides a close-up view of these fascinating creatures in their natural habitat. It can be a source of entertainment and relaxation, bringing the sights and sounds of nature to one's doorstep. Bird feeders help individuals feel more connected to the natural world, even in urban or suburban environments. Feeding birds can instill a sense of wonder and appreciation for the environment and the wildlife that shares it. Bird feeders offer excellent educational opportunities for individuals and families. Observing birds up close allows people to learn about different species, their behaviors, feeding habits, and migratory patterns. It's a hands-on way to teach children about the natural world. Some people use bird feeders as a means to contribute to bird conservation efforts. By providing supplementary food, especially during harsh seasons like winter, they help support local bird populations and mitigate potential food shortages. Also bird feeders can add beauty and life to outdoor spaces like gardens and yards. Colorful birds visiting feeders can enhance the visual appeal of the area and create a more inviting atmosphere.

There are several types of bird feeders available in the market like platform feeders, tube feeders, suet feeders, hummingbird feeders etc. each designed to attract different types of birds and accommodate various types of birdseed or feed. The present invention aims to provide an innovative solution that addresses common challenges associated with traditional bird feeders. Its mess reduction, weed prevention, pest deterrence, aesthetic appeal, ease of maintenance, versatility, enhanced bird-watching, visibility, reduced seed waste, and customizable feeding options make it a significant improvement over previous bird feeder inventions. It offers a more enjoyable and efficient bird-feeding experience for enthusiasts while maintaining a cleaner and more controlled feeding environment.

### SUMMARY OF THE INVENTION

The present invention relates to a novel bird seed feeder designed to address several common issues associated with messy bird feeding. In an embodiment of the present invention, the bird seed feeder comprises an upper bowl and a lower bowl, both constructed from transparent materials to maximize visibility. The upper bowl is inverted and placed atop the lower bowl, creating an enclosure that offers a controlled feeding environment. The upper bowl features a spacious entry hole that allows birds to hop inside for seed consumption. A circular perch surrounds the entry hole, providing a resting place for birds before they enter the assembly. The inverted upper bowl serves as a seed mess containment system so that when birds feed and kick seeds, the upper bowl to confine the waste, considerably reducing mess. In order to prevent larger birds, squirrels, and other pests from disturbing the feeder, the upper and lower bowls are designed with a stepped, overlapping joint.

In an embodiment of the present invention, the lower bowl is equipped with hooks that facilitate hanging the feeder from branches, hooks, or other suitable supports. The underside of the lower bowl is designed to be essentially flat, allowing users to place it on a table or any flat surface.

In an embodiment of the present invention, seed refilling can be accomplished by pouring seeds directly into the upper bowl's entry hole. The upper bowl can be conveniently lifted off while the lower bowl remains hanging. This facilitates the emptying of seeds into a waste receptacle. In order to maximize the viewer's wildlife experience, the joint between the upper and lower bowls is positioned near the bottom of the assembly. The smooth, curved shape of the upper and lower bowls ensures that birds appear less distorted while feeding, enhancing the overall visual appeal of the feeding area.

In conclusion, the transparent bird seed feeder with seed mess reduction system described herein presents an innovative and effective solution to the problem of messy bird feeding. This invention not only benefits bird enthusiasts by maintaining a cleaner feeding area but also provides an attractive and functional addition to any outdoor space, thereby enhancing the overall bird-watching experience.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 illustrates a perspective assembled view of a transparent bird seed feeder in accordance with an embodiment of the present invention;

FIG. 2 illustrates a perspective exploded view of the transparent bird seed feeder in accordance with an embodiment of the present invention;

FIG. 3 illustrates is a front view of the transparent bird seed feeder in accordance with an embodiment of the present invention;

FIG. 4 illustrates a rear view of the transparent bird seed feeder in accordance with an embodiment of the present invention;

FIG. 5 illustrates a top view of the transparent bird seed feeder in accordance with an embodiment of the present invention;

FIG. 6 illustrates a bottom view of the transparent bird seed feeder in accordance with an embodiment of the present invention;

FIG. 7 illustrates a left side view of the transparent bird seed feeder in accordance with an embodiment of the present invention;

FIG. 8 illustrates a right side view of the transparent bird seed feeder in accordance with an embodiment of the present invention;

### DETAILED DESCRIPTION OF THE INVENTION

Additional features and advantages of the invention will be outlined in the description which follows, and in part will be obvious from the description, or may be learned by the practice of the invention. These and other features of the present invention will become more fully apparent from the following description or may be learned by the practice of the invention as set forth hereinafter.

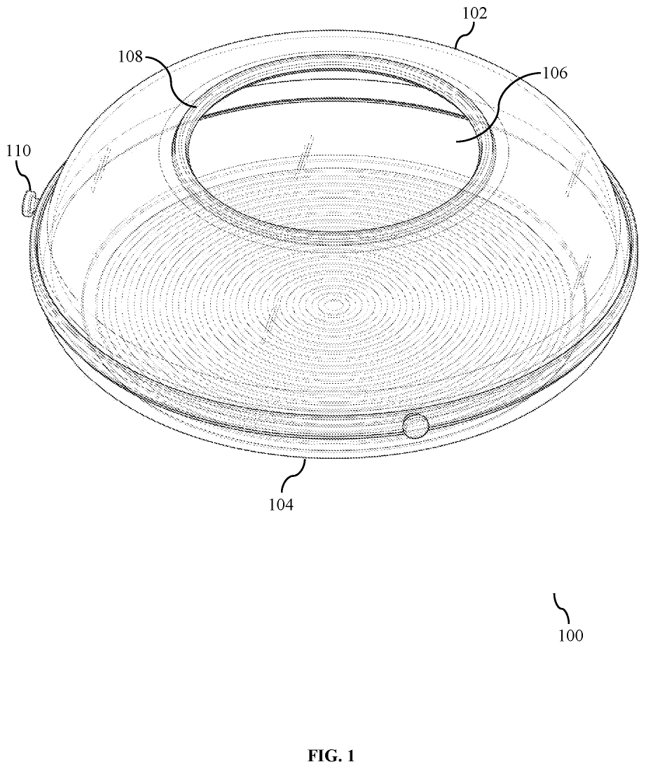

With reference now to the FIG. 1 thereof, an embodiment 100 of the bird seed feeder to which birds are attracted by the presence of seeds placed inside the upper bowl 102 which are visible from outside because the upper bowl 102 and lower bowl 104 are constructed from clear and transparent material, typically a plastic such as acrylic, polycarbonate and ABS. These materials provide visibility for birdwatchers and allows them to see the birds feeding. Birds land on the circular perch 108 surrounding the entry hole 106 in the upper bowl and from there they can hop inside the upper bowl through the entry hole 106 and access the seeds within. As birds feed, they kick seeds around but the inverted upper bowl serves as a barrier that contains the scattered seeds and waste generated by the feeding birds, significantly reducing mess. The joint mechanism, positioned near the bottom of the feeder, helps to deter larger birds, squirrels, and pests from disturbing the feeding area thus maintaining a controlled feeding environment. To maintain and refill the feeder, users can lift off the upper bowl 102 while leaving the lower bowl 104 in place thus allowing easy seed disposal into a waste receptacle and refilling through the entry hole. The clear material of both the upper and lower bowls ensures maximum visibility, enabling birdwatchers to enjoy an unobstructed view of the feeding birds and enhancing their wildlife-watching experience. The reduced seed spillage not only maintains a cleaner feeding area but also prevents the growth of undesirable garden weeds caused by fallen seeds. In order to keep larger birds, squirrels, and pests at bay, the feeder incorporates a stepped, overlapping joint between the upper and lower bowls. This design discourages unwanted visitors and maintains a controlled feeding environment. The smooth, curved shape of the bowls ensures that birds appear less distorted while feeding. This not only enhances the visual appeal of the feeding area but also provides a more natural and enjoyable bird-watching experience. The feeder offers user-friendly maintenance options and allows for easy seed refilling by pouring seeds into the upper bowl's entry hole. Users can lift off the upper bowl while the lower bowl remains hanging, facilitating the disposal of seeds into a waste receptacle. The joint between the upper bowl 102 and lower bowl 104 is strategically located near the bottom of the assembly, maximizing the viewer's wildlife experience by providing unobstructed views of feeding birds. The hooks 110 that protrude from the upper rim of the lower bowl would be visible from a perspective view. These hooks are designed for hanging the feeder from branches or other suitable supports. The perspective view would show how the hooks are positioned relative to the upper and lower bowls.

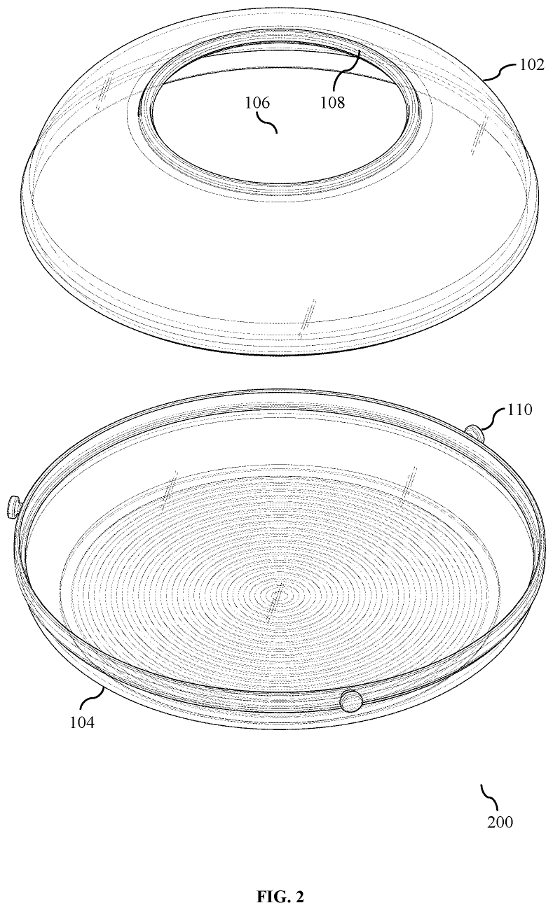

With reference now to the FIG. 2 thereof, an exploded embodiment 200 of the bird seed feeder comprising an upper bowl 102 constructed from clear and transparent material, typically plastic or acrylic, polycarbonate and ABS. The transparent material provides visibility for birdwatchers and allows them to see the birds feeding. The upper bowl 102 features a smooth, curved shape to ensure that birds appear less distorted when they feed, enhancing the overall aesthetic appeal. At the center of top of the upper bowl, there is a large entry hole 106 through which birds can enter the bird seed feeder and access the seeds. This entry hole 106 is strategically designed to accommodate the size of the small to medium bird species. Surrounding the entry hole 106 there is a circular perch 108 for birds to rest on this perch before entering the feeder, making it a comfortable and convenient spot for them.

Similarly like upper bowl, the lower bowl 104 is made from clear material, matching the upper bowl for consistency and visibility. The lower bowl's shape complements that of the upper bowl, creating a cohesive design when both the bowls are assembled. It also provides a smooth and curved surface for birds to feed from. The hooks in the above-disclosed bird seed feeder invention serve a crucial purpose related to its functionality and versatility. The primary purpose of the hooks is to provide a means for hanging the bird seed feeder. Users can attach the feeder to branches, hooks, poles, or other suitable supports using these hooks. This elevated positioning helps keep the feeder out of reach of ground-dwelling pests, such as squirrels and rodents, which can be a common problem with ground-level bird feeders. By hanging the feeder, it remains stable and secure. This prevents it from easily tipping over, especially during windy conditions or when larger birds land on it. The hooks ensure that the feeder maintains a steady position, preventing seed spillage. The height at which the feeder hangs, facilitated by the hooks, helps deter pests like squirrels and larger birds from accessing the seeds. These animals often struggle to reach the feeder when it's suspended from a branch or support. The presence of hooks allows users to choose the ideal location for the feeder. They can position it in a spot that offers good visibility for birdwatching while maintaining control over the feeding environment.

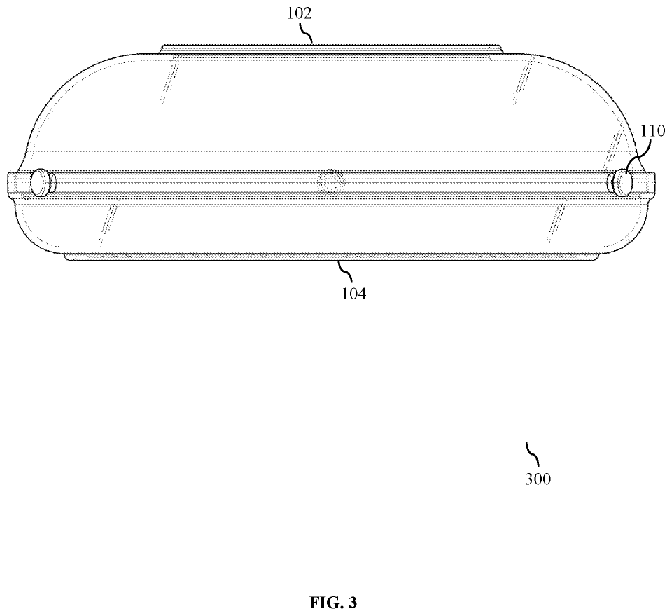

With reference now to the FIG. 3 thereof, a front view embodiment 300 of the transparent bird seeder is disclosed showcasing its key components and features. The upper bowl 102 is the top section of the feeder, featuring a clear, transparent material. The central feature of the upper bowl's front view is the large entry hole which is strategically positioned to allow birds easy access to the seeds inside. Beneath the upper bowl 102 is the lower bowl 104 which also has a clear and transparent construction, complementing the shape of the upper bowl 102 creating a cohesive and visually appealing design. The hooks 110 protruding from the upper trim of the lower bowl visible from the front view are used for hanging the feeder from branches, hooks, or other supports. The joint mechanism is positioned near the bottom of the feeder assembly, ensuring that it is not obstructing the view of feeding birds.

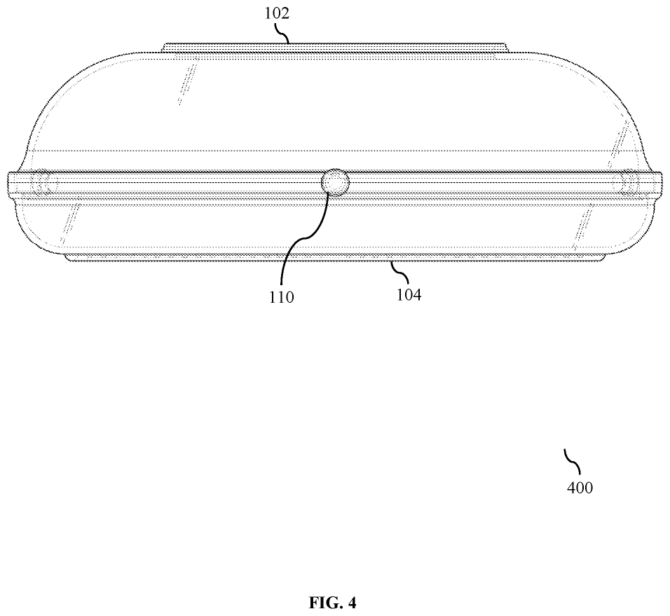

With reference now to the FIG. 4 thereof, a rear view embodiment 400 of the transparent bird seeder is disclosed wherein from the rear view, the upper bowl 102 is visible as the top portion of the feeder maintaining its clear and transparent material, allowing you to see the seeds inside. Beneath the upper bowl 102, lower bowl 104 is also visible with its clear construction complementing the upper bowl. The lower bowl's smooth, curved shape is evident from the rear view too, contributing to the feeder's overall aesthetic appeal. The hooks 110 designed for hanging the feeder from branches protruding from the upper ring of the lower bowl are clearly visible from the rear view.

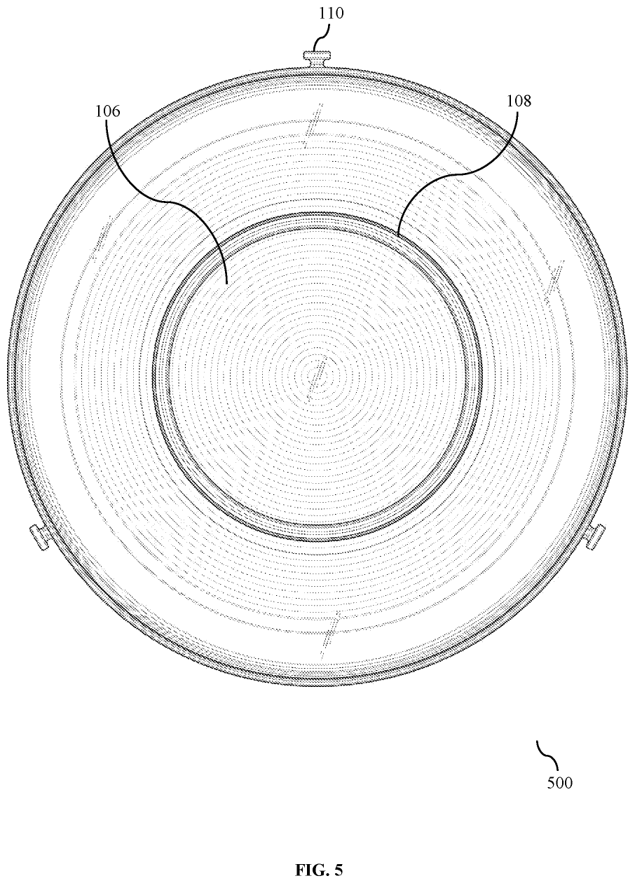

With reference now to the FIG. 5 thereof, a top view embodiment 500 of the transparent bird seeder is disclosed wherein the upper side is visible as the top section of the feeder maintaining a clear and transparent material, allowing you to refill the seeds inside from a large entry hole 106, which serves as the primary access point for birds to enter the feeder. Surrounding the entry hole, the circular perch 108 is typically visible from the top view allowing birds to land on this perch before entering the feeder to access the seeds. The top view typically reveal the circular or oval shape and configuration of the bird seed feeder created by upper and lower bowls when assembled. The hooks 110 designed for hanging the feeder from branches or other supports protruding from the upper rim of the lower bowl 104 are visible from the top view

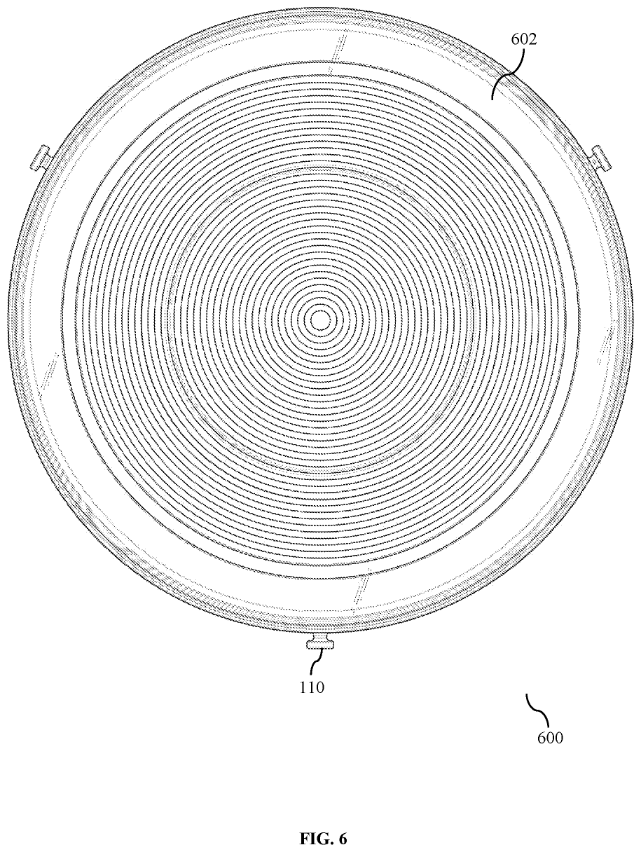

With reference now to the FIG. 6 thereof, a bottom view embodiment 600 of the transparent bird seeder is disclosed illustrating the underside of the lower bowl which is typically flat and level, making it suitable for placement on tables, flat surfaces, or hanging. The hooks 110 that protrude from the upper rim of the lower bowl are visible in the bottom view. These hooks are used for hanging the feeder from branches, hooks, or other suitable supports. While the joint mechanism, positioned near the bottom of the feeder assembly, may not be as conspicuous in the bottom view, some elements of it might be visible, depending on the feeder's design. The bottom view offers a perspective of the overall shape and configuration of the bird seed feeder, as created by the lower bowl revealing the circular or oval shape when viewed from below.

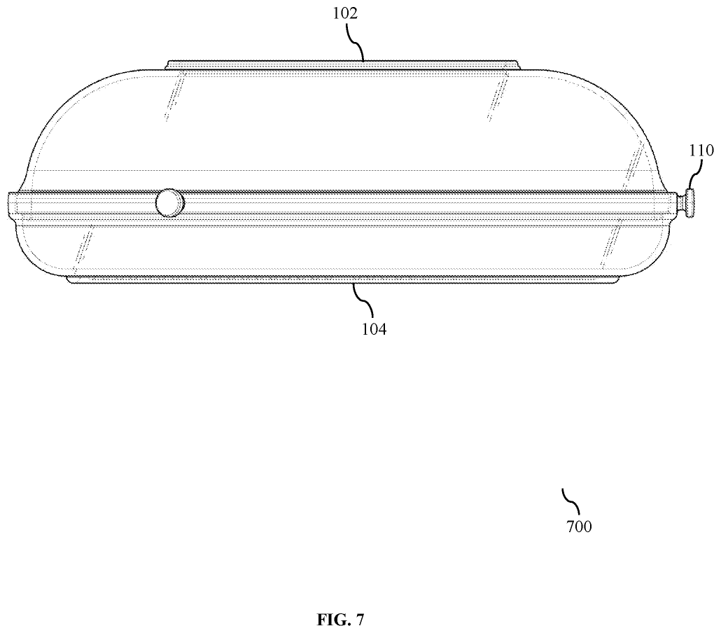

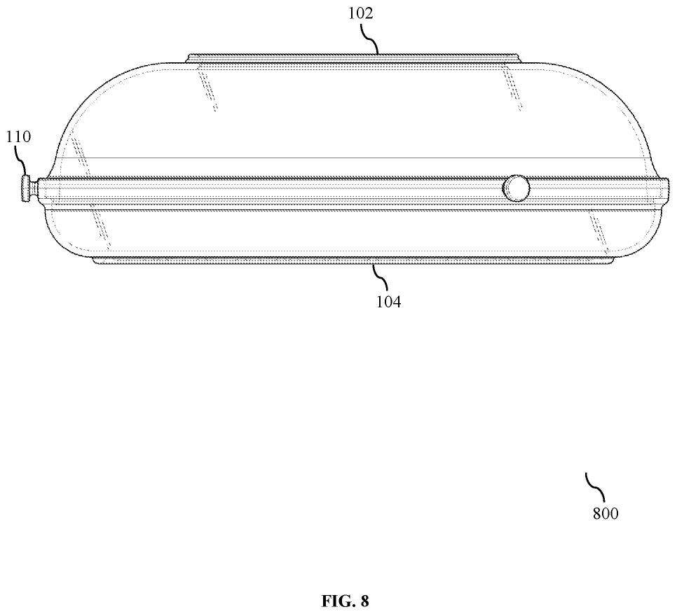

With reference now to the FIG. 7 and FIG. 8 thereof, a left side view embodiment 700 and a right side view embodiment 800 of the transparent bird seeder is disclosed wherein upper bowl is visible as the top section of the feeder and lower bowl is positioned beneath the upper bowl, complementing its shape and clear construction. Some hooks protruding from the upper rim of the lower bowl may be partially visible from the left side view and some from the right side view. The joint mechanism, located near the bottom of the feeder assembly, may not be as prominent in the left side view. However, some aspects of its design and placement may be observable from this angle. The left side view and right side view provides a perspective of the overall shape and configuration of the bird seed feeder, showcasing the circular or oval shape created by the upper and lower bowls when viewed from the side.

In an embodiment of the present invention, the bird feeder may comprise an adjustable entry hole mechanism, for providing enhanced control over the types of bird species accessing the feeder for eating seeds. This mechanism comprises a drop-in plate with a smaller hole that can be attached securely over the large entry hole on the upper bowl of the feeder. Various attachment mechanisms, including but not limited to clips, hooks, magnetic attachments, or other suitable means, can be employed to hold the drop-in plate in place.

In an alternative embodiment of the present invention, the bird seed feeder may have additional upper bowl complementing the primary upper bowl and features a smaller entry hole, strategically positioned to restrict access to specific bird species thereby allowing for precise customization of the feeding experience. Users can easily switch between the two upper bowls to achieve their desired bird feeding objectives, enhancing their bird-watching experience and fostering a diverse avian habitat.

The above-disclosed bird seed feeder invention offers several advantages over traditional bird feeders, making it an innovative and valuable solution for bird enthusiasts:
Mess Reduction: One of the primary advantages is its ability to significantly reduce mess. The inverted upper bowl design contains scattered seeds and waste, preventing them from falling to the ground. This feature keeps the feeding area cleaner and reduces the need for constant cleanup.
Weed Prevention: By minimizing seed spillage, this feeder helps prevent the growth of weeds in the garden. Traditional feeders can contribute to weed growth as seeds fall and take root, but this design mitigates that issue.
Pest Deterrence: The stepped, overlapping joint between the upper and lower bowls serves as a deterrent to larger birds, squirrels, and pests. This helps maintain a controlled feeding environment and ensures that the intended bird species can access the seeds.
Aesthetic Appeal: The smooth, curved shape of the feeder's bowls enhances the visual appeal of the feeding area. It also ensures that birds appear less distorted while feeding, providing a more natural and enjoyable bird-watching experience.
Ease of Maintenance: Users can easily refill the feeder by pouring seeds into the upper bowl's entry hole. The upper bowl can be lifted off while the lower bowl remains hanging, simplifying seed disposal and refilling.
Versatility: The feeder can be hung from branches or other supports using the hooks on the lower bowl. Alternatively, it can be placed on tables or flat surfaces due to the flat underside of the lower bowl. This versatility accommodates various user preferences and garden setups.
Enhanced Bird-Watching: The joint between the upper and lower bowls is strategically located near the bottom of the feeder, ensuring an unobstructed view of feeding birds. This maximizes the viewer's wildlife-watching experience and allows for clear observation of the birds.
Visibility: Both the upper and lower bowls are made from clear, transparent material. This ensures maximum visibility of the seeds and the birds, enhancing the overall bird-watching experience.
Reduced Seed Waste: With the majority of spilled seeds being contained within the feeder, less seed is wasted. This can lead to cost savings for bird enthusiasts and a more sustainable feeding experience.
Customizable Feeding: Users have the flexibility to choose the type of seed they offer, allowing them to attract specific bird species to their garden.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein-and in particular, embodiment specifically contemplated, is intended to be practiced in the absence of any element which is not specifically disclosed herein.

1. A bird seed feeder comprising:
an upper bowl constructed from transparent material, said upper bowl featuring a large entry hole;
a lower bowl constructed from transparent material, positioned beneath said upper bowl, forming a smooth and curved structure;
multiple symmetrically positioned hooks protruding from the upper rim of said lower bowl for hanging the feeder from supports;
a joint mechanism located near the bottom of the feeder assembly, connecting said upper and lower bowls; and
a circular perch surrounding the entry hole on said upper bowl.

2. The bird seed feeder according to claim 1, wherein the entry hole on said upper bowl serves as the primary access point for birds to enter and access the seeds.

3. The bird seed feeder according to claim 1, wherein the stepped, overlapping joint between said upper and lower bowls deters large birds, squirrels, and pests from accessing the feeder.

4. The bird seed feeder according to claim 1, wherein the upper bowl can be removed from the lower bowl for easy refilling and maintenance while the lower bowl remains hanging.

5. The bird seed feeder according to claim 1, wherein the feeder's design reduces mess by containing scattered seeds and waste, preventing them from falling to the ground.

6. The bird seed feeder according to claim 1, wherein the circular perch surrounding the entry hole provides a resting place for birds before entering the feeder.

7. The bird seed feeder according to claim 1, wherein the feeder offers versatility in placement, allowing it to be hung from supports using the hooks or placed on plain surfaces due to its flat underside.

8. The bird seed feeder according to claim 1, wherein the upper bowl and lower bowl are made of clear transparent material and with their join located near the bottom of assembly to maximize the visibility and shape of both the bowls is curved smooth making the birds less distorted in appearance when eating.

9. The bird seed feeder according to claim 1, wherein the upper bowl may include an adjustable entry hole mechanism comprising a drop-in plate with a smaller entry hole in its center configured with a means for securely attaching the said drop-in plate over the larger entry hole, said means including mechanisms including but not limited to clips, hooks, or magnetic attachment.

10. The bird seed feeder according to claim 1, wherein the apparatus may include additional upper bowl with a smaller entry hole for placing above the lower bowl, allowing users to choose between two distinct entry hole sizes.
